(19) United States
(12) Patent Application Publication
(10) Pub. No.: US 2017/0350354 A1
(43) Pub. Date: Dec. 7, 2017

(54) PULSE DAMPER

(71) Applicant: Eaton Corporation, Cleveland, OH (US)

(72) Inventors: James P. Ostrosky, Brighton, MI (US); Jim James, Ann Arbor, MI (US); Keith Westwood, Dudley (GB)

(73) Assignee: Eaton Corporation, Cleveland, OH (US)

(21) Appl. No.: 15/685,041

(22) Filed: Aug. 24, 2017

Related U.S. Application Data
(63) Continuation of application No. PCT/US2016/019485, filed on Feb. 25, 2016.
(60) Provisional application No. 62/121,258, filed on Feb. 26, 2015.

(51) Int. Cl. F02M 37/00; F16L 55/053; F15B 1/12; F16L 55/055; F15B 1/02

(52) U.S. Cl. CPC F02M 37/0041; F16L 55/055; F15B 1/021; F15B 1/125; F16L 55/053

(57) ABSTRACT

A pulse damper constructed in accordance to one example of the present disclosure includes a first housing member, a second housing member, a diaphragm and a valve. The first housing member defines a fuel chamber at an internal space thereof. The first housing member can further have a fuel inlet and a fuel outlet. The second housing member can define a pressurized chamber. The diaphragm can be disposed between the first and second housing. The diaphragm separates the fuel chamber and the pressurized chamber. The valve can be disposed on the second housing and be configured to selectively pass air into and out of the pressurized chamber corresponding to a desired predetermined pressure within the pressurized chamber. Increased pressure within the pressurized chamber will resist movement of the diaphragm into the pressurized chamber.

### CROSS-REFERENCE TO RELATED APPLICATIONS

This application is a continuation of International Application No. PCT/US2016/019485 filed Feb. 25, 2016, which claims priority to U.S. Provisional Application No. 62/121,258 filed on Feb. 26, 2015, which is incorporated by reference in its entirety as if set forth herein.

### FIELD

The present disclosure relates generally to pulse dampers and more particularly to a pulse damper configuration on an automobile fuel system.

### BACKGROUND

Pulse dampers are used to minimize periodic increases and decreases in pressure in a gas or liquid handling device. In one application, pulse dampers are used in automobile fuel systems to reduce pressure amplitude that may lead to unwanted sound transmitted to a vehicle exterior or passenger compartment. In addition, pulse dampers are used as a mechanism to reduce load transmittal to mating components such as brackets and fuel injectors. Furthermore, pulse dampers are used to maintain fuel delivery pressure for improved engine crank times. While current pulse dampers are generally satisfactory for their intended purpose, a need in the art exists to provide an improved pulse damper.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A pulse damper constructed in accordance to one example of the present disclosure includes a first housing member, a second housing member, a diaphragm and a valve. The first housing member defines a fuel chamber at an internal space thereof. The first housing member can further have a fuel inlet and a fuel outlet. The second housing member can define a pressurized chamber. The diaphragm can be disposed between the first and second housing. The diaphragm separates the fuel chamber and the pressurized chamber. The valve can be disposed on the second housing and be configured to selectively pass air into and out of the pressurized chamber corresponding to a desired predetermined pressure within the pressurized chamber. Increased pressure within the pressurized chamber will resist movement of the diaphragm into the pressurized chamber.

According to other features, the valve is a Schrader valve. A crimp ring can couple the first and second housings together. The crimp ring can sealingly couple the first and second housings together with the diaphragm sandwiched therebetween. The second housing member can be dome shaped. The first and second housing members can be formed of steel. In another configuration, the second housing member can be formed of plastic. The first housing member can be formed of plastic. The first gasket can be disposed between the first housing and the diaphragm. The second gasket can be disposed between the second housing and the diaphragm. The valve can further comprise a threaded stem having a removably coupled cap. The diaphragm can be formed of Polyimide film. The crimp ring can be formed of one of steel and aluminum.

A pulse damper constructed in accordance to another example of the present disclosure includes a plastic first housing member, a plastic second housing member and a diaphragm. The plastic first housing member defines a fuel chamber at an internal space thereof. The first housing member can further have a fuel inlet and a fuel outlet. The plastic second housing member can define a pressurized chamber. The diaphragm can be disposed between the first and second housing and can separate the fuel chamber and the pressurized chamber.

According to additional features, the pulse damper can further comprise a crimp ring that couples the first and second housings together. The crimp ring can sealingly couple the first and second housing together with the diaphragm sandwiched therebetween. The second housing member can be dome shaped. A first gasket can be disposed between the first housing and the diaphragm. The second gasket can be disposed between the second housing and the diaphragm. The diaphragm can be formed of Polymide film. The crimp ring can be formed of one of steel and aluminum.

### BRIEF DESCRIPTION OF THE DRAWINGS

The present disclosure will become more fully understood from the detailed description and the accompanying drawings, wherein:

FIG. 1 is a perspective view of a pulse damper constructed in accordance with one example of the present disclosure;

FIG. 2 is a sectional view of the pulse damper of FIG. 1 taken along lines 2-2;

FIG. 3 is a sectional view of the pulse damper of FIG. 1 taken along lines 3-3;

FIG. 4 is a perspective view of a pulse damper constructed in accordance to another example of the present disclosure;

FIG. 5 is a sectional view of the pulse damper of FIG. 4 taken along lines 5-5;

FIG. 6 is an exploded view of the pulse damper of FIG. 4;

FIG. 7 is a cross-sectional view of a pulse damper according to one example of;

FIG. 8 is a plot illustrating engine speed versus time for a fuel supply line without a pulse damper and for a fuel supply line with a pulse damper;

FIG. 9 shows a comparison of a first plot illustrating a diesel system having 1400 rpm fuel pump velocity without a pulse damper and a second plot illustrating a diesel system having a pulse damper;

FIG. 10 is an exploded view of a pulse damper constructed in accordance to another example of the present disclosure;

FIG. 11 is a cross-sectional view of the pulse damper of FIG. 10 shown in an assembled position;

FIG. 12 is a cross-sectional view of the pulse damper of FIG. 10 shown prior to crimping a crimp ring;

FIG. 13 is a front view of the pulse damper of FIG. 10 and shown in an assembled position;

FIG. 14A shows a pulse damper having a 0.8 mm thick steel crimp ring according to other examples of the present disclosure; and

FIG. 14B shows a pulse damper having a 1.6 mm thick crimp ring constructed of either 304 stainless steel or 1010 steel.

### DETAILED DESCRIPTION

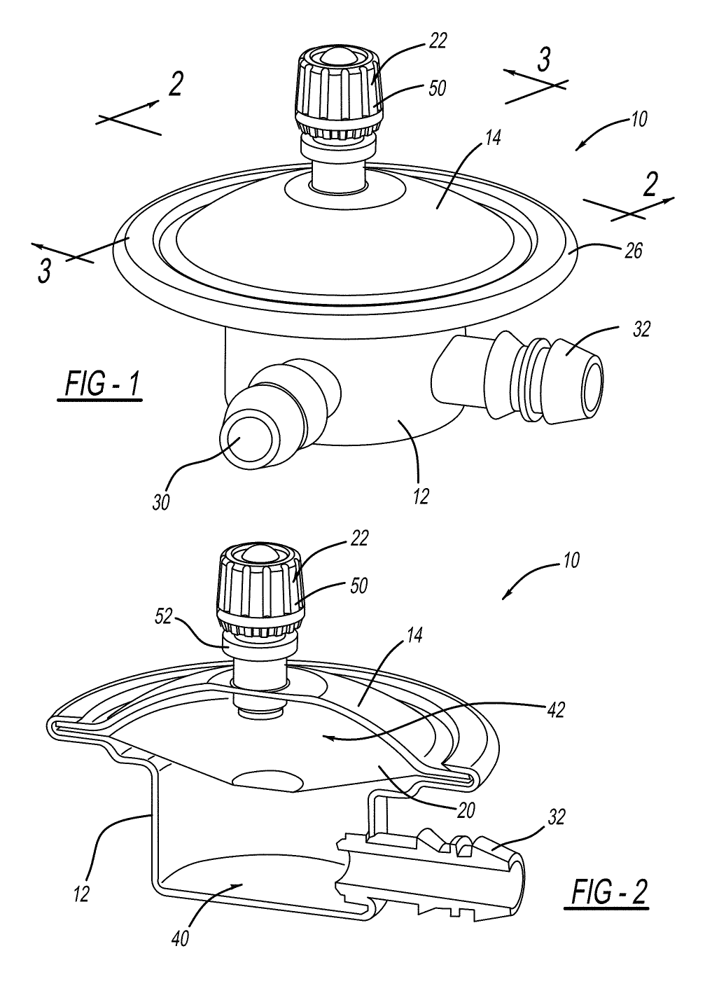

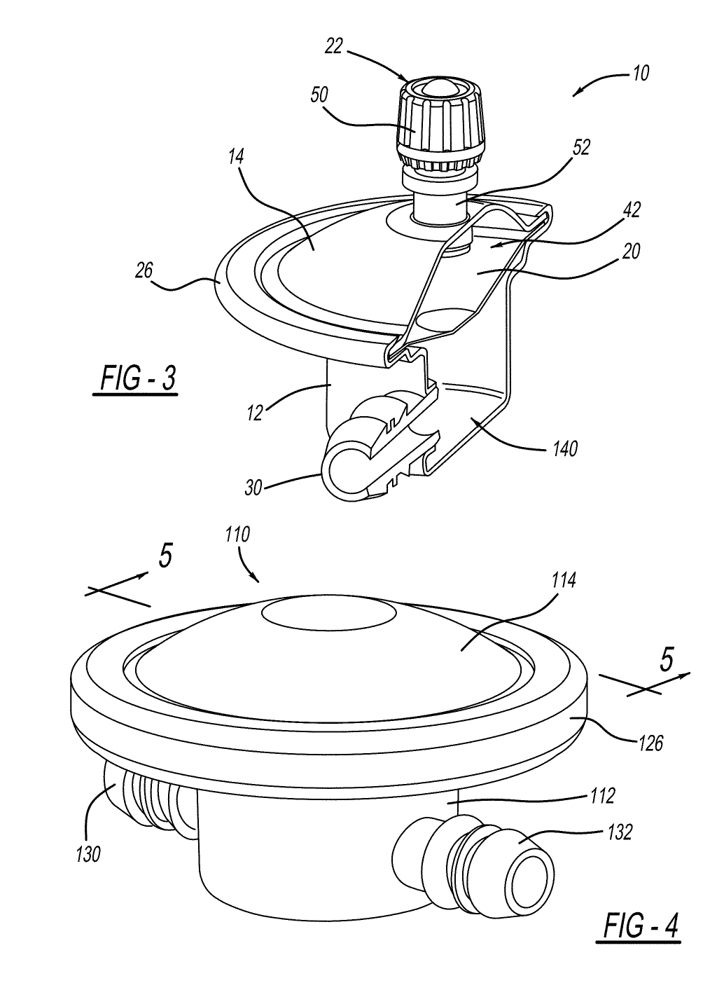

With initial reference to FIGS. 1-3, a pulse damper constructed in accordance to one example of the present disclosure is shown and generally identified at reference numeral 10. The pulse damper 10 can generally include a first housing member 12, a second housing member 14, a diaphragm 20, a valve 22 and a crimp ring 26. In some examples the crimp ring 26 can be integrally formed with the first or second housing member 12, 14. In other examples, the crimp ring 26 may be separately formed. The first housing member 12 can include a fuel inlet 30 and a fuel outlet 32. The fuel inlet 30 and the fuel outlet 32 can take the shape of ribbed fittings or other structures.

The first housing member 12 defines a fuel chamber 40 at an internal space thereof. The second housing member 14 defines a pressurized chamber 42. The diaphragm 20 can be disposed between the first and the second housing members 12 and 14. The diaphragm 20 can separate the fuel chamber 40 and the pressurized chamber 42. In general, as fuel is passed from the fuel inlet 30 to the fuel outlet 32, pressure can act against the diaphragm 20 in a direction generally from the fuel chamber 40 into the pressurized chamber 42. The diaphragm 20 can move and as a result mitigate pressure amplitude.

The pulse damper 10 according to the present disclosure includes the valve 22. The valve 22 can be used to selectively pass air into and out of the pressurized chamber 42. As can be appreciated, more air in the pressurized chamber 42 will tend to resist movement of the diaphragm 20 toward the pressurized chamber 42. In this regard, a user can set the pressurized chamber 42 to have a predetermined pressure suitable for a given application. The valve 22 can be a Schrader valve. A cap 50 can be removably secured to a corresponding threaded stem 52. Other configurations are contemplated.

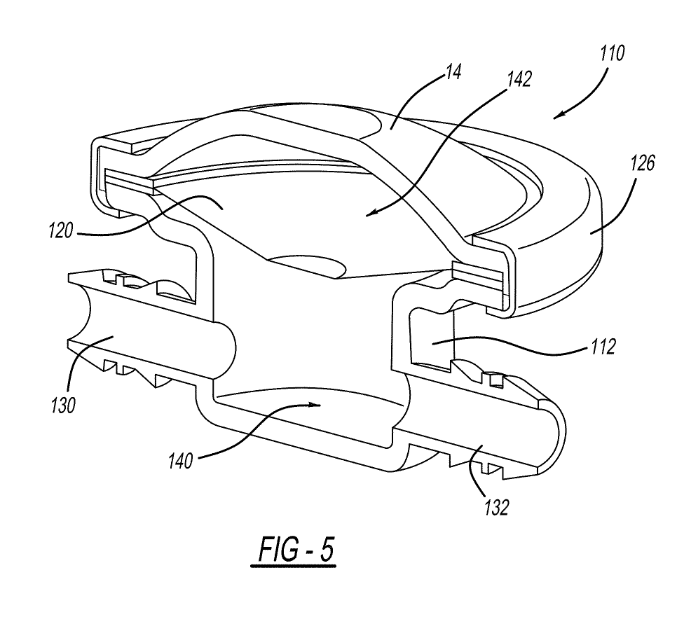

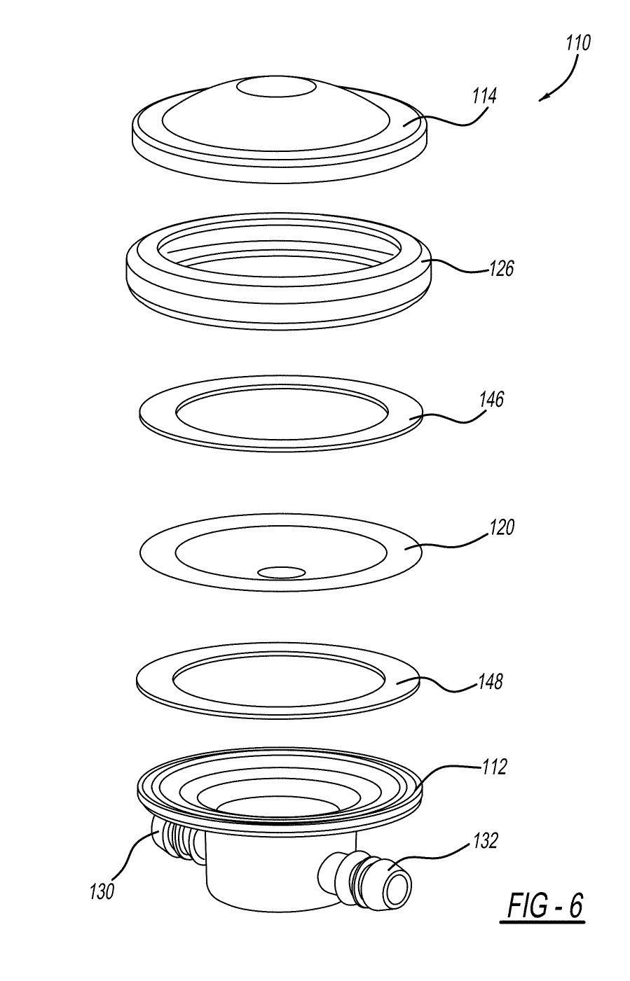

Turning now to FIGS. 4-6, a pulse damper constructed in accordance to another example of the present disclosure is shown and generally identified at reference 110. The pulse damper 110 can generally include a first housing member 112, a second housing member 114, a diaphragm 120, and a crimp ring 126. The crimp ring 126 may be separately formed. The first housing member 112 can include a fuel inlet 130 and a fuel outlet 132. The fuel inlet 130 and the fuel outlet 132 can take the shape of ribbed fittings or other structures. As will become appreciated from the following discussion, the first and second housing members 112 and 114 are formed out of plastic. The first and second housing members 112 and 114 can be injection molded. The diaphragm 120 can be overmolded. The plastic first and second housing members 112 and 114 can reduce weight and costs while still performing at high levels. The crimp ring 126 can be formed of metal such as steel or aluminum.

The first housing member 112 defines a fuel chamber 140 at an internal space thereof. The second housing member 114 defines a pressurized chamber 142. The diaphragm 120 can be disposed between the first and the second housing members 112 and 114. The diaphragm 120 can separate the fuel chamber 140 and the pressurized chamber 142. In general, as fuel is passed from the fuel inlet 130 to the fuel outlet 132, pressure can act against the diaphragm 120 in a direction generally from the fuel chamber 140 into the pressurized chamber 142. The diaphragm 120 can move and as a result mitigate pressure amplitude. A first gasket 146 can be disposed between the first housing 112 and the diaphragm 120. A second gasket 148 can be disposed between the second housing 114 and the diaphragm 120. The first and second gaskets 146 and 148 can be formed of fluorocarbon. The diaphragm 120 can be formed of Polyimide film. In other examples, the first and second housing members 12 and 14 of the pulse damper 10 can be formed of plastic.

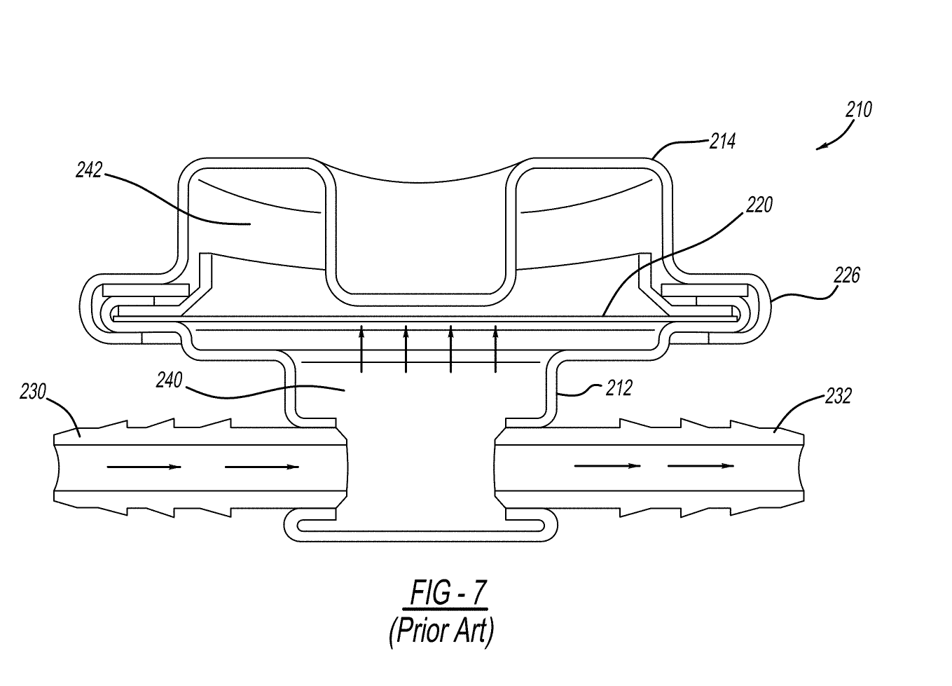

With reference now to FIG. 7, an exemplary pulse damper constructed in accordance to prior art is shown and generally identified at reference 210. The pulse damper 210 generally includes a first housing member 212, a second housing member 214, a diaphragm 220, and a crimp ring 226. The crimp ring 226 may be integrally formed with one of the first or second housing members 212, 214 or separately formed. The first housing member 212 can include a fuel inlet 230 and a fuel outlet 232. The fuel inlet 230 and the fuel outlet 232 can take the shape of ribbed fittings or other structures.

The first housing member 212 defines a fuel chamber 240 at an internal space thereof. The second housing member 214 defines a pressurized chamber 242. The diaphragm 220 can be disposed between the first and the second housing members 212 and 214. The diaphragm 220 can separate the fuel chamber 240 and the pressurized chamber 242. In general, as fuel is passed from the fuel inlet 230 to the fuel outlet 232, pressure can act against the diaphragm 220 in a direction generally from the fuel chamber 240 into the pressurized chamber 242. The diaphragm 220 can move and as a result mitigate pressure amplitude.

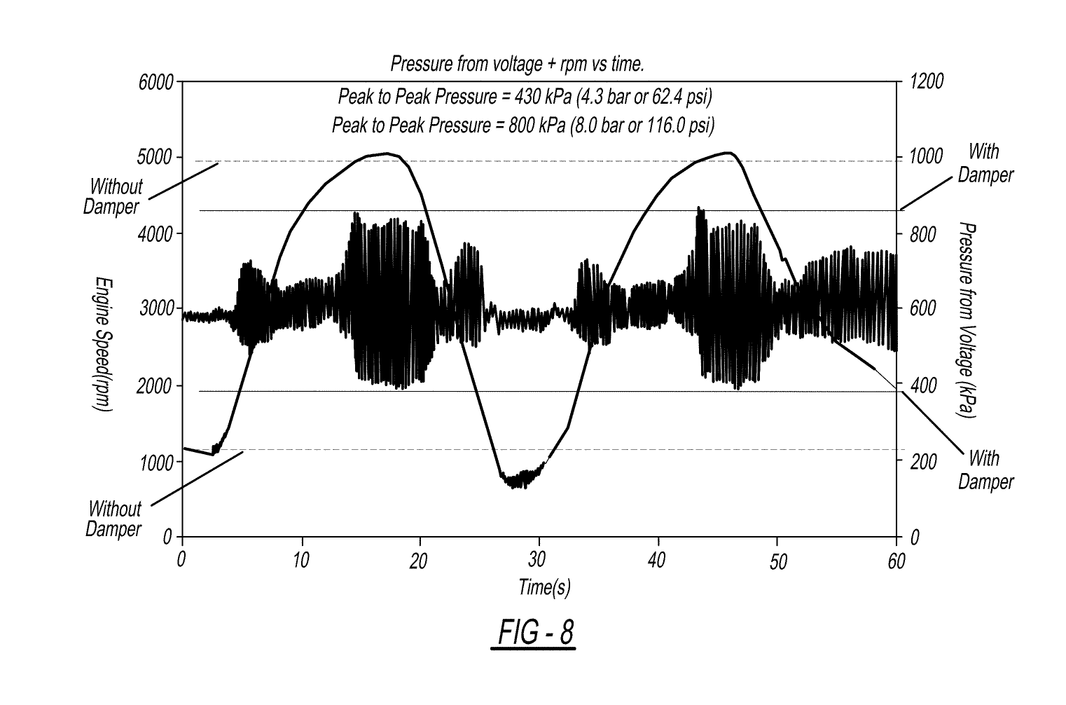

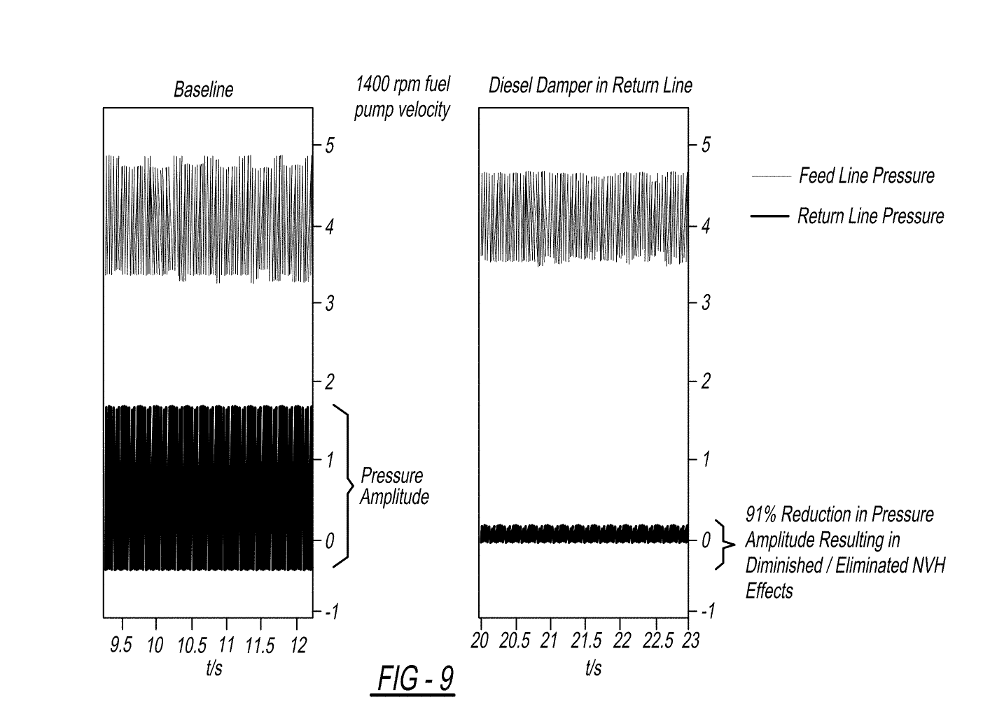

FIG. 8 is a plot illustrating engine speed versus time for a fuel supply line having a pulse damper compared to a fuel supply line without a pulse damper. As shown, the plot with the pulse damper provides improved pressure mitigation. FIG. 9 shows a comparison of a first (baseline) plot illustrating a diesel system having 1400 rpm fuel pump velocity without a pulse damper (left) and a second plot illustrating a diesel system having a pulse damper (right). Similar improved results can be attained with other RPMs. Those skilled in the art will appreciate that 1400 RPM is used for exemplary purposes.

The pulse dampers disclosed herein can be used as pressure accumulators. The accumulator can function to provide high pressure gasoline direct injection (GDI). The accumulator can compensate for injector leakage, fuel thermal expansion and contraction. The accumulator can inhibit long-cranking engine starts.

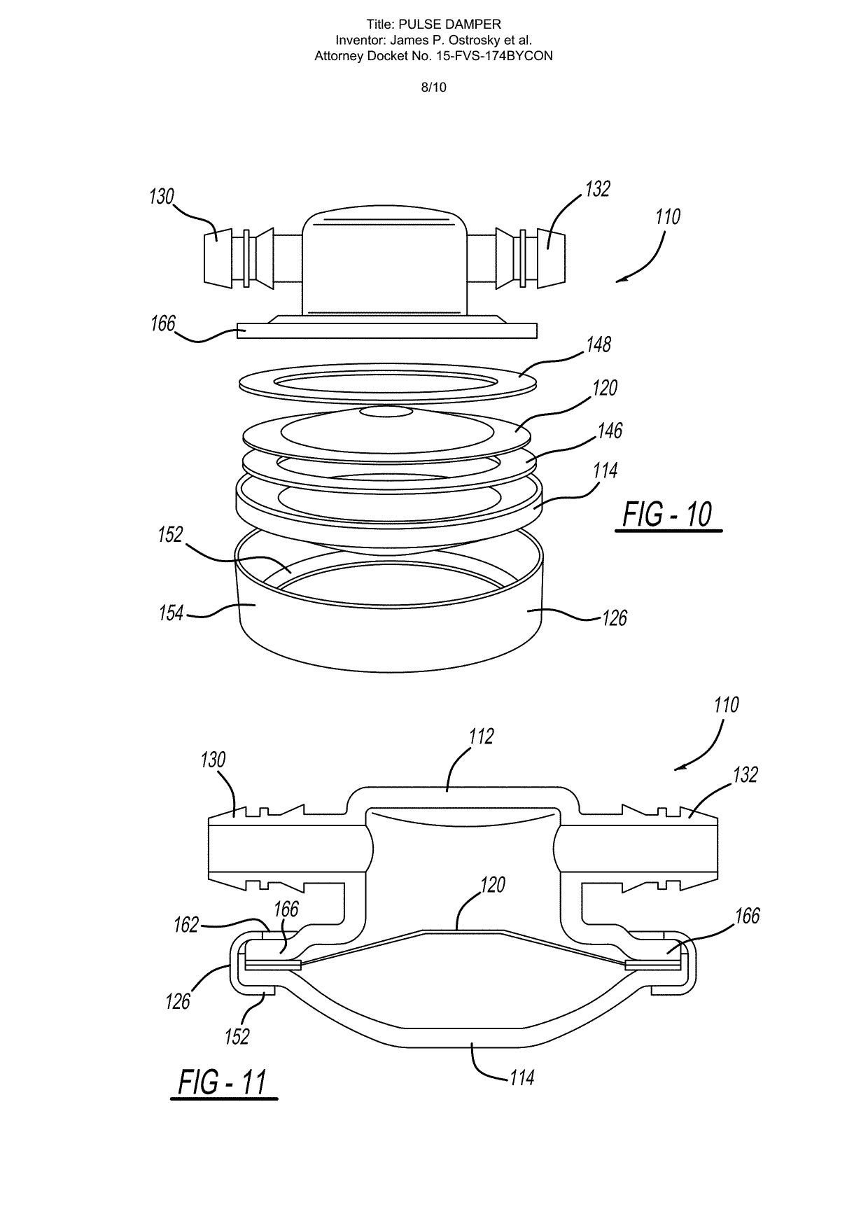

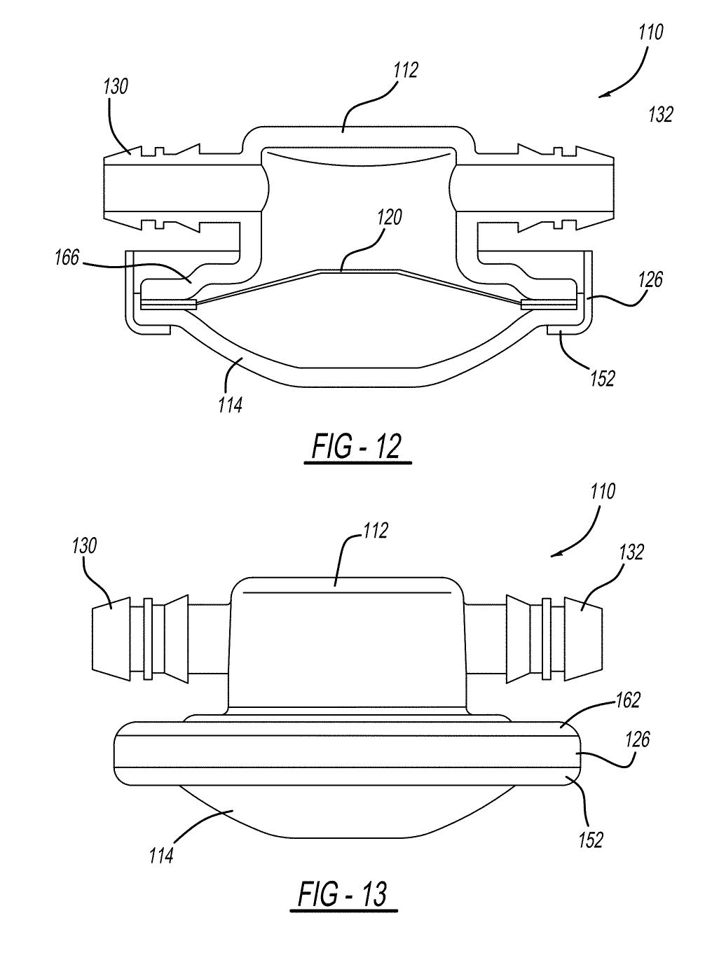

The pulse damper disclosed herein provides many advantages over prior art offerings. The pressure on the non-fuel side (pressurized chamber 42) can be varied to meet application requirements for pressure pulsation magnitude. The pressure at which a customer has determined to meet all requirements can then be built into the production level damper. FIG. 10 is an exploded view of the pulse damper 110 described above with respect to FIGS. 4-6 and prior to forming of the crimp ring 126. Of note, in one configuration, the crimp ring 126 can have a first annular lip 152 and an upright radial wall 154. In some examples, the second housing 114, the first gasket 146, the diaphragm 120, the second gasket 148 and the first housing member 112 can be advanced to a position within an inner diameter boundary of the upright radial wall 154 during assembly to a position shown in FIG. 12. Subsequently, an upper portion 162 of the crimp ring 126 can be deformed up and around a rim portion 166 of the first housing member 112 capturing the respective components.

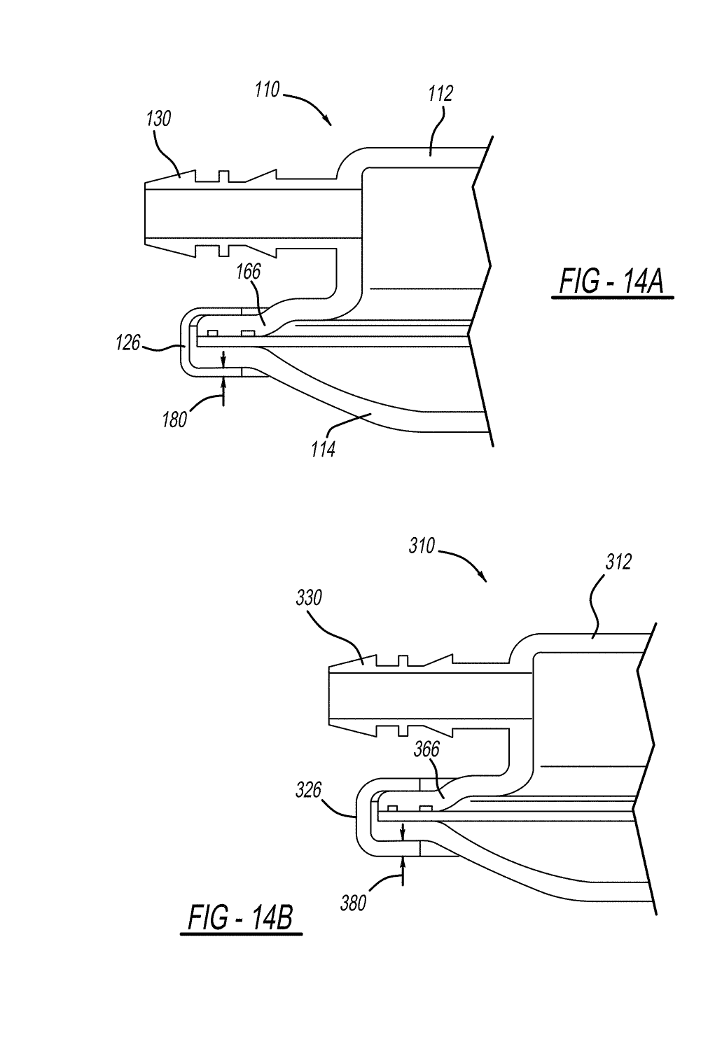

FIG. 14A shows the pulse damper 110 wherein the crimp ring 126 has a thickness 180. The thickness 180 can be 0.8 mm. FIG. 14B shows a pulse damper 310 wherein a crimp ring 326 has a thickness of 380. Like reference numerals from the damper 110 increased by 200 are used for the damper 310 shown in FIG. 14B. The thickness 380 can be 1.6 mm. The crimp rings 126 and 326 can be formed of either 304 stainless steel or 1010 steel.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A pulse damper comprising:
a first housing member that defines a fuel chamber at an internal space thereof, the first housing member further having a fuel inlet and a fuel outlet;
a second housing member that defines a pressurized chamber;
a diaphragm disposed between the first and second housing and that separates the fuel chamber and the pressurized chamber; and
a valve disposed on the second housing and configured to selectively pass air into and out of the pressurized chamber corresponding to a desired predetermined pressure within the pressurized chamber, wherein increased pressure within the pressurized chamber will resist movement of the diaphragm into the pressurized chamber.

2. The pulse damper of claim 1 wherein the valve is a Schrader valve.

3. The pulse damper of claim 1, further comprising a crimp ring that couples the first and second housings together.

4. The pulse damper of claim 3 wherein the crimp ring sealingly couples the first and second housings together with the diaphragm sandwiched therebetween.

5. The pulse damper of claim 1 wherein the second housing member is dome shaped.

6. The pulse damper of claim 5 wherein the first and second housing members are formed of steel.

7. The pulse damper of claim 5 wherein the second housing member is formed of plastic.

8. The pulse damper of claim 7 wherein the first housing member is formed of plastic.

9. The pulse damper of claim 5, further comprising:
a first gasket disposed between the first housing and the diaphragm; and
a second gasket disposed between the second housing and the diaphragm.

10. The pulse damper of claim 1, wherein the valve further comprises a threaded stem having a removably coupled cap.

11. The pulse damper of claim 1 wherein the diaphragm is formed of Polyimide film.

12. The pulse damper of claim 3 wherein the crimp ring is formed of one of steel and aluminum.

13. A pulse damper comprising:
a plastic first housing member that defines a fuel chamber at an internal space thereof, the first housing member further having a fuel inlet and a fuel outlet;
a plastic second housing member that defines a pressurized chamber; and
a diaphragm disposed between the first and second housing and that separates the fuel chamber and the pressurized chamber.

14. The pulse damper of claim 13, further comprising a crimp ring that couples the first and second housings together.

15. The pulse damper of claim 14 wherein the crimp ring sealingly couples the first and second housings together with the diaphragm sandwiched therebetween.

16. The pulse damper of claim 13 wherein the second housing member is dome shaped.

17. The pulse damper of claim 13, further comprising:
a first gasket disposed between the first housing and the diaphragm; and
a second gasket disposed between the second housing and the diaphragm.

18. The pulse damper of claim 13 wherein the diaphragm is formed of Polyimide film.

19. The pulse damper of claim 14 wherein the crimp ring is formed of one of steel and aluminum.

20. The pulse damper of claim 13 further comprising:
a valve disposed on the second plastic housing member and configured to selectively pass air into and out of the pressurized chamber to provide a predetermined pressure within the pressurized chamber, wherein increased pressure within the pressurized chamber will resist movement of the diaphragm into the pressurized chamber.
